(19) United States
(12) Patent Application Publication
(10) Pub. No.: US 2007/0191966 A1
(43) Pub. Date: Aug. 16, 2007

(54) Theatrical Objects Automated Motion Control System, Program Product, And Method

(76) Inventors: Scott M. Fisher, Las Vegas, NV (US); Taras Hrechyn, Lviv (UA)

Correspondence Address: LEWIS AND ROCA LLP, 40 NORTH CENTRAL AVENUE, PHOENIX, AZ, 85004, US

(21) Appl. No.: 11/548,211

(22) Filed: Oct. 10, 2006

Related U.S. Application Data
(60) Provisional application No. 60/729,368, filed on Oct. 20, 2005.

(51) Int. Cl. G05B 15/00

(52) U.S. Cl. 700/1

(57) ABSTRACT

A theatrical objects automated motion control system, program product, and method provide, in various implementation, provide techniques for large scale motion and device control. Non-hierarchical art theatrical object movement techniques are provided, wherein combinations of multiple devices on a network include devices functioning as would a single machine. Full-function scalability is provided from one to many machines, wherein neither processor nor device boundaries exist but rather each device has to option of exchanging its operational data with that any other device at any time, in real time. Techniques are provided for coordinating the moving of objects, such as is part of a theatrical performance on a stage in performance venues, and wherein examples of these objects include theatrical props, cameras, stunt persons (e.g., “wirework”), lighting, scenery, drapery and other equipment.

### CROSS NOTING

The non-provisional utility application claims priority to US Provisional Application Serial No. 60/729,368, titled Theatrical Objects Automated Motion Control System, Program Product, and Method, filed on Oct. 20, 2005, which is incorporated herein in its entirety by reference.

### TECHNICAL FIELD

The present invention relates generally to coordinated movement of objects, and is more particularly related to a system to control the motion of theatrical objects.

### BACKGROUND

To enhance a realistic atmosphere of a theatrical production, it is known in the stage craft arts to move theatrical objects during and between scenes on a stage or motion picture production set. Automation of such movement is desirable for safety, predictability, efficiency, and economics. Prior art theatrical object movement systems use motorized movement under control of microprocessors. The motorized movement can be provided, by way of example and not by way of limitation, by winch drive motors having variable speed drives coupled to a central computer, such as by an axis controller. Examples of such prior art theatrical object movement systems are seem in U.S. Pat. Nos. 5,920,476 and 6,297,610. Each of these references teach control of a large number of devices via computers executing lists of sequential actions. Each list provides instructions, for example, for motor driven winches. U.S. Pat. No. 5,920,476 describes computer controlled motion systems for theater that includes a physical interface. U.S. Pat. No. 6,297,610 provides a means of connecting multiple field devices (motors) to a lesser number of control devices (drives), which lowers installation costs. Each such prior art system, however, is necessarily hierarchical. That is, there's a definite progression from operator controls to data network to control device to field device.

It would be an advance in both the art of large scale motion and device control as well as the stage craft arts to provide greater flexibility and speed than is provided by hierarchical prior art theatrical object movement systems, wherein the system has no hierarchy, and wherein the combination of multiple devices on a network of the system that includes those devices will function as would a single machine. It would be a further advantageous in these arts, given such a system functioning as a single machine, to provide full-function scalability from one machine up to thousands, wherein neither processor nor device boundaries exist but rather each device has to option of exchanging its operational data with that any other device at any time, in real time.

### SUMMARY

A theatrical objects automated motion control system, program product, and method provide, in various implementations, provide techniques for large scale motion and device control. By way of example, non-hierarchical art theatrical object movement techniques are provided, wherein combinations of multiple devices on a network include devices functioning as would a single machine. Full-function scalability is provided from one to many machines, wherein neither processor nor device boundaries exist but rather each device has to option of exchanging its operational data with that any other device at any time, in real time. By way of further example, techniques are provided for coordinating the moving of objects, such as is part of a theatrical performance on a stage in performance venues such as theaters, arenas, concert halls, auditoriums, schools, clubs, convention centers and television studios, and wherein examples of these objects include theatrical props, cameras, stunt persons (e.g., “wirework”), lighting, scenery, drapery and other equipment.

### BRIEF DESCRIPTION OF THE DRAWINGS

FIGS. 1-8 depict an implementation of a user interface presented by way of screen shots for use of the Navigator system as further described herein.

### DESCRIPTION

Implementations provide a large scale motion and device control system. Other implementations provide a non-hierarchical art theatrical object movement system. In each such system, combinations of multiple devices on a network of the system that includes those devices function as would a single machine. In such systems full-function scalability is provided from one to many machines, wherein neither processor nor device boundaries exist but rather each device has to option of exchanging its operational data with that any other device at any time, in real time.

In one implementation, a system coordinates moving objects, such as is part of a theatrical performance on a stage. The implementation includes an automation system for movement of objects in performance venues such as theaters, arenas, concert halls, auditoriums, schools, clubs, convention centers and television studios, wherein examples of these objects include theatrical props, cameras, stunt persons (e.g., “wirework”), lighting, scenery, drapery and other equipment.

In another implementation, described by way of example, a theatrical performance may call for a battle scene. In the battle, a 1^{st} stunt person is to fly through the air and then collide with a 2^{nd} stunt person, where the 2^{nd} stunt person is struck so hard that the 2^{nd} stunt person is thrown backward into and through a wall. To set up this stunt, each of the 1^{st} and 2^{nd} stunt persons is hung from respective cables. Each cable is attached to a separate winding mechanism powered by an electrical motor—for instance, a winch. In the stunt, the 1^{st} stunt person falls while attached to a cable towards the 2^{nd} stunt person, while the winch stops the cable, and thus the 1^{st} stunt person's movement, just has the 1^{st} stunt person hits the 2^{nd} stunt person. While not seen by the audience, each player wears some padding so that their minor impact will not hurt either player. The 2^{nd} winch is synchronized to pull on the cable attached to the 2^{nd} stunt person so hard that it appears that the 2^{nd} stunt person had be struck by the 1^{st} stunt person. The 2^{nd} winch then continues to pull the 2^{nd} stunt person's cable until the 2^{nd} player's body hits an easily breakable wall. Finally, the 2^{nd} winch stops the 2^{nd} stunt person's cable when the 2^{nd} stunt person's body has passed through the easily breakable wall.

In the above stunt, coordination of the winding and reeling between the 1^{st} and 2^{nd} winches is critically important to the stunt persons' safety. This coordination is one capability of this implementation.

The implementation includes an automation system for movement of such objects in performance venues such as theaters, arenas, concert halls, auditoriums, schools, clubs, convention centers and television studios. Such venues employ machines, such as winches, hoists, battens, or trusses to move various objects relative to a stage or floor. Examples of these objects include theatrical props, cameras, stunt persons (e.g., “wire work”), lighting, scenery, drapery and other equipment. These objects are moved about the venue during a live performance and/or during the filming of a scene. Controlling the movement of these objects can be critical to the safety of the actors and to make the movement seem realistic. This automation system controls the movement of these objects.

Numerous logical ‘nodes’ are used in this implementation. Each node is independently operated and self-aware, and is also aware of at least one other node in this implementation. That is, each node is aware that at least one other node is active or inactive (e.g., online or off line).

A machine that moves an object is referred to as an ‘axis’ in the implementation. Examples axes include engines, motors (AC/DC), servos, hydraulic movers, and pneumatic movers. Each axis is assigned to a logical node in the implementation.

An axis driver controls a machine that moves an object. Thus, an axis controller is a machine controller. Logically, each ‘axis’ is a process that runs under the QNX real time operating system (O/S), as set forth in Appendix B. QNX is a Unix-like real-time micro kernel O/S that runs a number of small tasks, known as servers. The micro kernel allows unneeded functionality to be turned off simply by not running the unneeded servers. QNX is a robust O/S, that is, it is not likely to crash.

A ‘player’ in the implementation ‘plays’ a list or queue of motion commands, each of which provides rules or instructions to an axis driver based on conditions set by the rule. For instance, the rule may specify limitations on velocity, position or location, whether the axis is enabled or disabled, and when and whether the axis is to stop its movement. The instructions that are performed by the axis driver are dependent upon the conditions that have been satisfied. When a condition is satisfied, the axis driver ‘goes active’ and performs those instructions that are permitted by that satisfied condition.

The conditions set by rules allow for movement of the axes to be coordinated and interrelated to one or more other axes. For instance, there can be one node that is assigned to each of a number of winches that wind and unwind respective cables. A node may also be assigned to a supervisory safety system which monitors the status of each of the winches to ensure compliance with all expected statuses. The supervisory safety system node can also turn off power to any winch that is non-compliant with its expected status. There may also be two nodes assigned to an ‘operating controller’. The operating controller can monitor data from each winch, share that data with all other axes, and also displays that data.

The movement and status of each axis/machine assigned to a node can be related both to itself and to the movement and status of each other axes/machine that is assigned to a respective node.

For an example of conditional movement rules that can be placed upon the winding and unwinding of a “First Winch”: when the First Winch is making a winding motion, but its winding speed is below a maximum speed and the end of the cable being wound by the First Winch is located farther away than a minimum separation from the end of a second cable of a “Second Winch”, then the First Winch will stop and then unwind its cable by a predetermined length. The end of the cable of the First Winch can be controlled as to permissible lengths with maximum positions and maximum speeds, such as by setting a limit on a maximum velocity of the winding of the cable so as to be based upon the velocity of the end of the cable of another winch that is assigned to another node in the system.

Each winch or hoist, as well as other such machines that move objects, is similarly controlled by the system of the implementation as an individual, independent system. As such, the system maintains redundancy in that each machine/axis has its own individual node with each node being in communication with all other nodes. If an individual machines turn off, nodes corresponding to the other machines in the system will ‘load share’ and communicate with remaining processors for the respective other nodes. As such, the system is self-healing and self-configuring—that is, it finds paths to route data from each machine to where that data is needed by other machines in the system.

During a performance, a node can go off line and then come back on line. When coming back on line, the node can automatically identify itself to other nodes in the system to announce that it is back on line. Since every machine has its own node, if a node goes offline, the network is still present and functioning as a collection of the remaining on line nodes.

This implementation can provide a ‘global node’ that collects information and saves all machine data to a central location for later back up of that data. The global node, for instance, can show a display of those nodes that have a load of friction in the system (e.g., those nodes that are associated with the movement of objects).

Users of this implementation have the common experience of working with sets interrelated axes (machines), where arguments for the axes are run by players. Each argument has lists of motion groups that define what list each motion group is in, which sub-list the motion group is in, and which queue the motion group is in. Constructs can be programmed to tie together and interrelate multiple machines/axes to a single point of control. Then, a operator can control and manipulate that single point in a three dimensional space so as to control various movement aspects of each of the machines/axes in that single point of control.

An emergency stop, such as single manually pushed button, can function in the system of the implementation to turn the power off simultaneously to all machines. When power is turned off to all machines, then a conventional mechanical brake on each machine activates to stop all movement.

Implementations disclosed herein provide a networking infrastructure in which there is a “data vector”. Data vectors for each machine are made available to all other modes in real time all the time. The data vector concept is used with the real-time networking architecture to allow a Navigator system operator to tailor the system to the show requirements in every aspect. These aspects include the way that a graphical user interface (GUI) is presented to the operator (e.g.; information, presentation, filtering, conditional displays, conditional color coding, conditional access), to conditional anti-collision and performance limiting measures (“Rules”), to the ability to write, record, edit, re-order, re-structure, and segregate the playback sequences at will, to the provision for any number of operator interfaces with multiple login levels to have access to the system simultaneously. Additionally, the ‘background’ aspects of this architecture make all of the operator-controlled functions possible without data conflicts, collisions, or loss.

Disclosed implementations provide features and tools that take advantage of the unique networking architecture. One such feature is intercommunication and data traffic control features that are inherent in the networking architecture as it applies to motion and process control, for example, for theatrical object motion control systems.

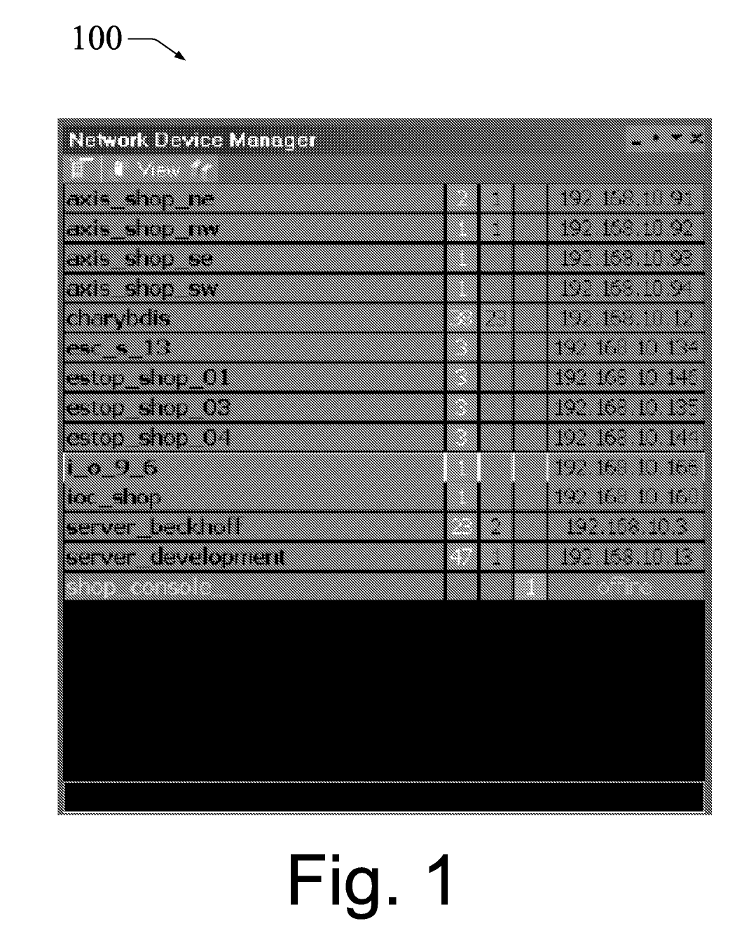

Specific examples are given to FIGS. 1-8 of screen shots that can appear on a display during operation of the Navigator System as set forth in Appendix A. In a screen shot 100 seen in FIG. 1, a table is depicted. The table in screen shot 100 shows that all of the devices on a network of the Navigator System are visible to an operator of the Navigator system. As such, the table provides a tabular overview of the devices in this implementation of the Navigator System. The table allows the system operator to view what is going on in the network from an operator interface (e.g.; a display monitor), screen shot 100 allows the system operator to look at all the different network modes, their addresses, what they are doing, how many processes they are running, and inter-device communications.

The left most column in the table of screen shot 100 gives the name of the node, where the node here is intended to be an individual computer on the network, such as a process controller, a thin client (e.g.; a Intel Pentium™ III processor with a memory adapter), a palm top computer, or a microprocessor. Each individual computer is running the QNX real time operating system as set forth in Appendix B.

The first column of the table in screen shot 100 shows several axes. Is intended to represent any piece of machinery that moves. The machinery might be operated by hydraulic, electric, or other means. There is a variety of different devices on the network axes which are the end machines make theatrical objects move, where the system operator(s) may have one or more interfaces at one or more consoles that allow the operator(s) to make inputs into the system, for instance by one or more input devices (a pointing device such as a mouse, a keyboard, a panel of buttons, etc.).

The four directional axes (northeast, northwest, southeast, southwest) each represent a computer node that controls a respective winch at four different corners of a theatrical environment (e.g.; a stage), where the cables thereof all converge to a single point so as to provide a three dimensional (3-D) movement system. The 3-D system allow the four (4) winches that connect at a single point to move the single point around in a 3-D space. In another implementation, a winch can control the movement of a camera, or other theatrical object (e.g.; people, set pieces, elevators) on the end of a cable that is being wound and unwound on the winch.

The row labeled “ESC _s_{—}13” and those labeled “estop” are emergency stop controller devices. These devices, for instance, can prevent theatrical objects from colliding if a system operator pushes an emergency stop button that causes a removing of power from the corresponding machine is moving. Then, brakes are applied in the absence of power and movement stops.

The “i_o_{—}9_{—}6” device is an input/output controller for getting command signals in and out of the system, usually from other systems, like light switches, or other system devices. There may be multiple channels of on off switches for turning on lights, for turning on object movement machines, etc., for whatever needs to be turned on and off. The “shop console” is a display that can be viewed by a system operator.

Any axis can be changed from hardware to an emergency stop process or controller in that all axes run a QNX RTOS process that operate in a common fashion. As such, all f the nodes acts as a single machine that functions as one unit. Screen shot 100 represents only some of the many other functions that the Navigator system can operate and control.

The second column in the table of screen shot 100 shows the number of different processes running on the device. The “charydbidis” device which has 38 processes running simultaneously. Each process shown in the green column is currently active and running on that node. Each computer is a multi-tasking computer to simultaneously run processes. One process can be a player. A player is run on an axis shop and ‘plays’ sequential lists of commands.

A process is a software machine. For the system to be able to move a motor on a winch to wind or reel, a process is run. The process is called axis, and the software machined process runs on the computer that instructs the corresponding motor as to movements. For instance, if the instruction given is to move a theatrical object at the end of a cable of a winch a total of 30 feet at 4 feet per second and then stop, the process will handle all of the calculations required to control the voltages and currents so that the instruction for the motor for the cable movement by the winch will be accomplished.

The rows labeled “server” correspond to thicker systems with large storage capacity (e.g.; hard drives) that can more robust computing tasks that other, smaller computers having limited memory.

The gray column after the green column shows the number of processes that are still on the corresponding node but are either disabled or inactive. The total of the green and grey columns in a row show the total processes on a node. The last column is the internet protocol (IP) address of the node. The red number in the last row indicates a diagnostic that a process is offline, such as being ‘unplugged’ or ‘not hooked up’ anymore. The system operator can see the red diagnostic and then ‘plug in’ the corresponding device.

As used herein, a ‘device’ can be a piece of hardware, like the computer. A device can also be a software device like a ‘player’ that is a ‘virtual machine’ which is not a tangible piece of machinery capable of being held in one's hand but is rather a software construct that is considered by the Navigator system to be a machine. The player feeds commands and receives back a status, yet doesn't exist as a physical machine.

Some types of devices are real and some are soft, though all are visible via screen shot 100 as being alive and running on the network.

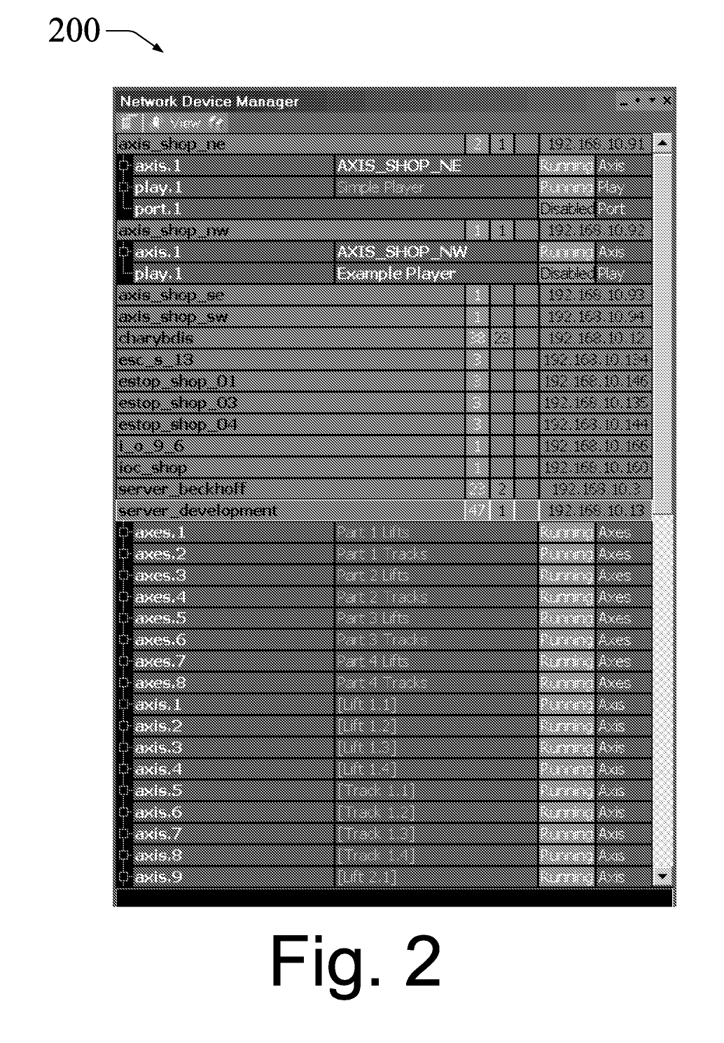

FIG. 2 shows, by a screen shot 200, an expansion of the rows on screen shot 100 in FIG. 1. Screen shot 200 shows the same node list as FIG. 1 as expanded to show the actual processes running on the system. An operator can ‘double click’ on a node name to cause an expanded display that shows the actual processes. On the axis_shop_NE row, the first ‘2’ is the axis on 1 and the player on 1 which are both running, and then the ‘1’ is a port 1 which is disabled. There these are the three (3) processes running on the axis_shop_NE, with one (1) disabled, 2 are active, and port 1 is the one that is disabled. By comparison, screen shots 100-200 demonstrate a tree structure showing nodes and processes ‘at a glance’, each of which can be expanded as branches on a tree.

Diagnostics are shown in the far right hand column, where ‘axis.1’ is said to be ‘running’ and the prior column shows the type of device. A “track” corresponds to plot in a staged deck that pushes a piece of machinery out on the stage, such as via a cable and winch arrangement. Screen shot 20 shows, in sum, that a single network node can run multiple processes.

When a device is disabled, the effect is that it is no longer available to the system for operation. The IP address would not disappear, depending upon the criticality of the device's failure. If the process itself died, a software problem has occurred, though the corresponding machine would still be seen in screen shot 200 as being offline as in a yellow color outlined column. As such, color can be used to inform a system operator as a variety of diagnostic messages (e.g., green is running, yellow is not running, and red for disabled.

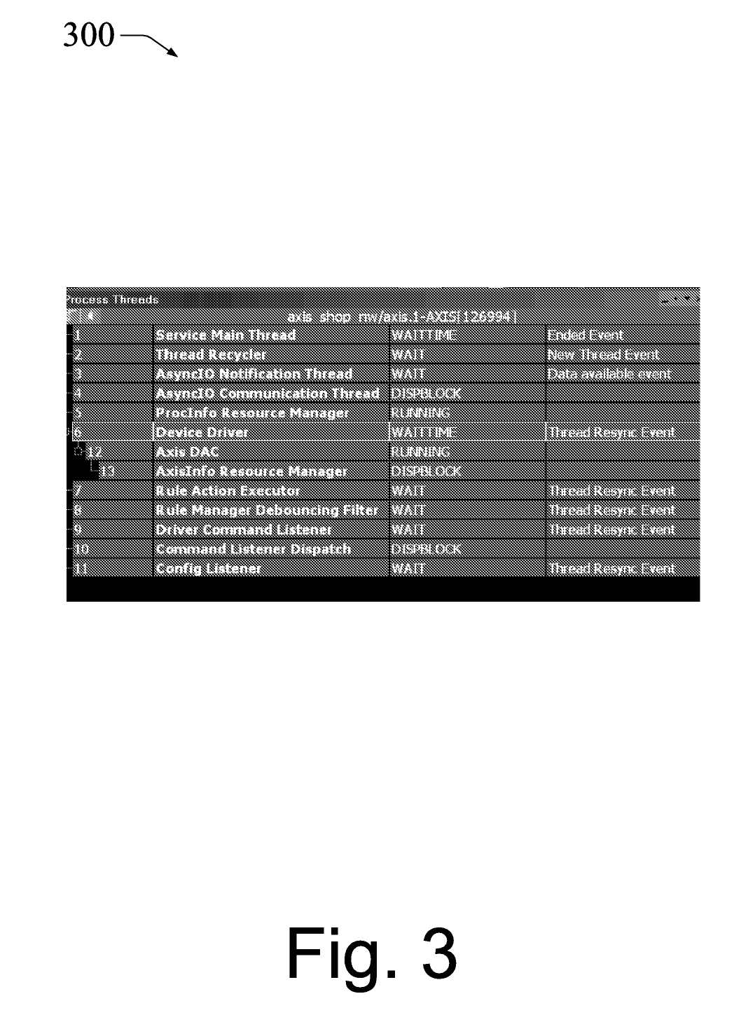

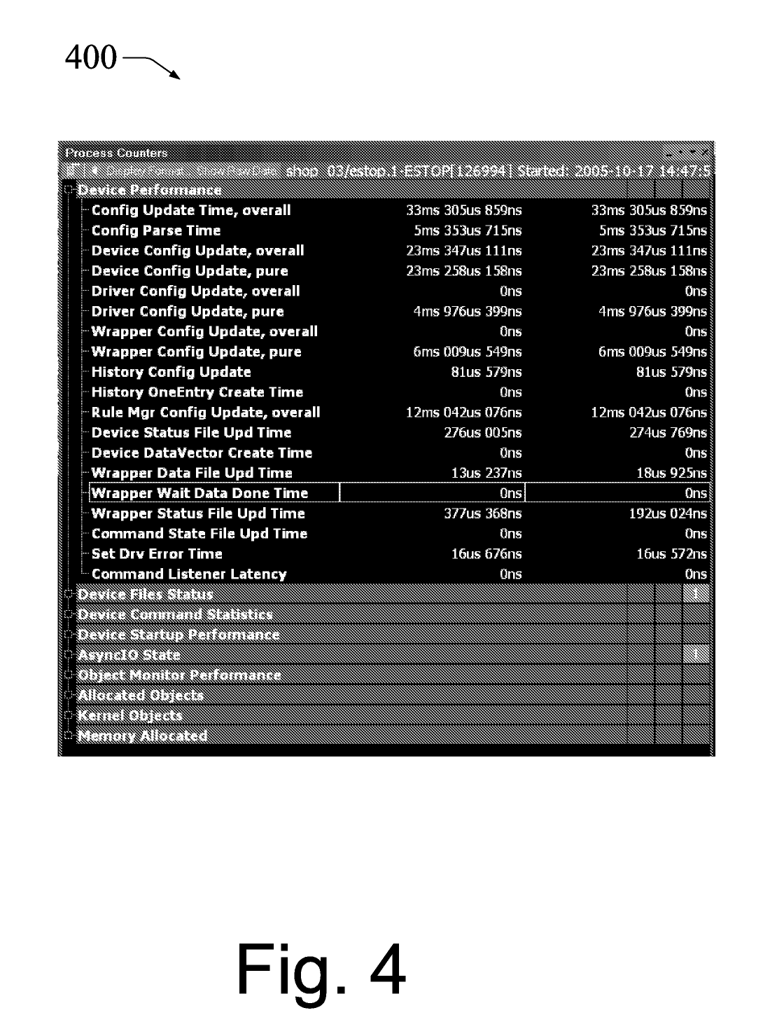

FIGS. 3-4 respectively showing screen shots 300-400 depicts process threads. These two screen shots show an example of the amount of data that is being monitored on each device on the threads that are running on each device. As shown, the display is organized hierarchically for its device processes and threads in each process. The device is a device manager and the process run on the device, where the threads are the instructions that run within the process. For instance, in screen shot 200 in FIG. 2, the ‘axis.1’ of the axis.shop.ne device is the axis process that gives instructions to a corresponding computer for providing instructions of a motor operating a winch, where those instructions control movement of the cable for the winch. A further explosion of the depicted table shows all of the threads that are running under an axis, including the receiving of instructions, the execution of received instructions, and other aspects of motion control of the axis.

Screen shot 300 shows what is happening on the axes.shop.nw axis, for a process thread ‘126994’ process. The number of threads vary depending on the process. One the number ‘6’ thread shown on screen shot 300 in FIG. 3, a device driver converts motion commands into voltage and frequency commands for the motor that spins at certain speeds. The axis deck is an axis digital analog controller for taking a digital signal from the corresponding computer and turning it into analog control signals. Then, corresponding calculations are made. If anything changes on the axis, that a management thread of the axis ensures that all the other machines on the network can be informed as to the change.

The “DISP” labeled row-block is a label for a process for displaying a block of data. The “WAIT” row-column shows, for a snapshot moment of time, a state of waiting for the next update. The ‘Thread Resync Event’ is the last action performed.

The screen shots show the intuitive, drill down operator usage of the Navigator system, making the system flexible. All data for all nodes is universally made available, including all every one of the processes so as to be shared with every other machine on the network all the time, so that every node is aware of the other nodes. Stated otherwise, with the QNX RTOS and the network management system, there are no processor boundaries, and data is not deemed to reside on separate processors. If one axis is controlled so as to care whether or not another axis is going too fast, the corresponding data will be known because all axes are constantly trading information via information packets (e.g.; IP protocol). The data can be stored, and made available to all the nodes, such as in a markup language format (e.g.; eXtensible Markup Language—XML).

Screen shot 400 in FIG. 4 gives an appreciation for the amount of data to which access is provided. The ‘estop.1’ process ‘126994’ from screen shot 300 is shown as being drilled down to show device performance, including process counters. The process is shown to have started at a date and time. This type of information is made available to all devices in the Navigator system so that information can be traded between devices in real time with every other device in the system all the time. As shown in screen shot 400, the status of a device's performance for one process includes device file status, device commands, other statuses, etc. For instance, the “Device File Status” row in screen shot 400 shows a green row-column, which is intended to indicate that there is one (1) file that is currently open.

The Navigator system has a structural organization that allows any type of device to be built while maintaining the same operational paradigm, whereby each device follows the same paradigm which all devices trading information.

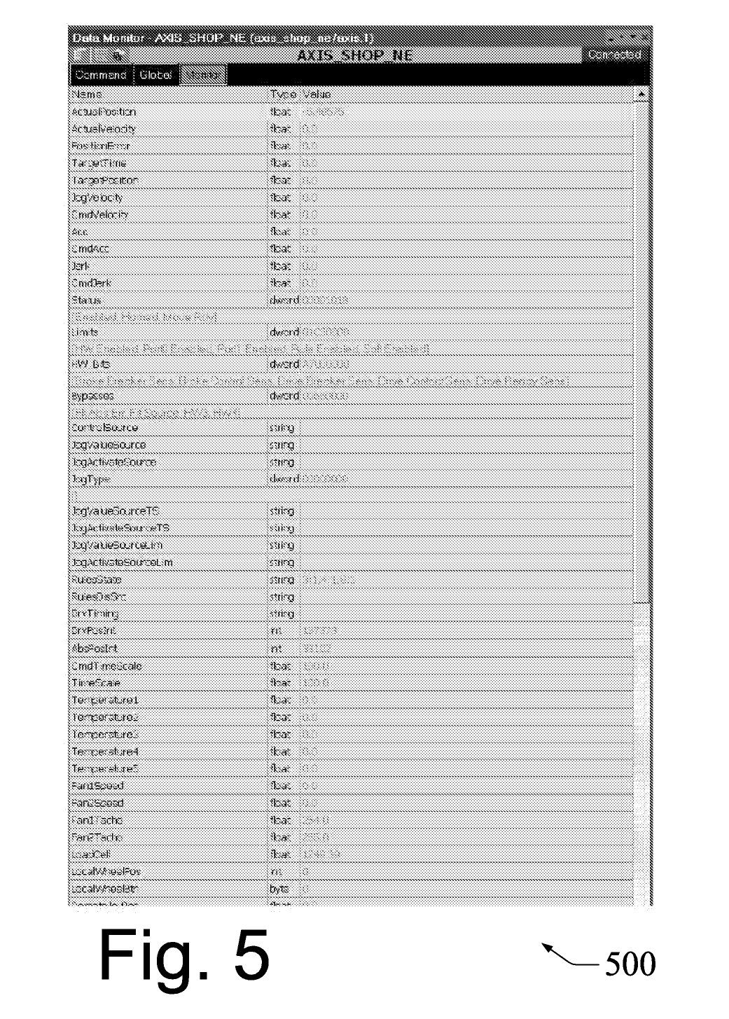

FIG. 5 shows, for the ‘axis_shop_NE’ device, a screen shot 500 which illustrates a table for a data vector which is traded (i.e.; made available to) with other devices. The “type” column shows the kind of string, and the “value” column depicts a rule state.

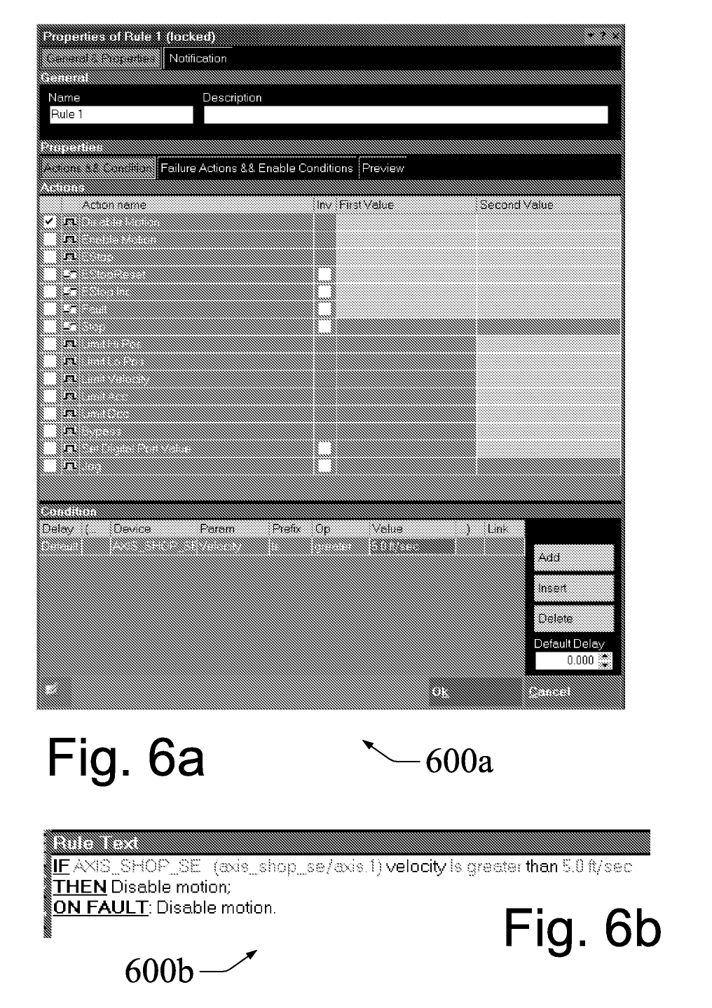

FIG. 6a shows screen shot 600a is an input screen for setting properties for a rule for a device (axis_shop_se). The input is translated into rule text in screen shot 600b in FIG. 6b, where the rule is written to disable the device's motion and under conditions if the axis_shop_SE device has a velocity is greater than five feet per second. The rules construct is a kind of programming tool for writing processes for machines.

The Navigator system will preferably be unlike prior art systems which handle their functionality using a completely separate subsystem called a programmable logic controller (PLC), where the system operator has to monitor the system via separate inputs as a separate system and take separate action on its own. Instead, the Navigator system provides all operational data for each node that is available to every node all the time, regardless of how each node is related to each other node. Screen shots 600a-600b present the novelty in a visible ramification of the network structure in which operational instructions for a device can be set in any way desired for any machine at any time, even on the fly. For example, theatrical object movement control can be changed at an operator console from one set up for a stage production having one set of rules to another set up having a different set of rules for maintenance procedure for the theatrical stage. As such, when a maintenance crew arrives and log in to the system, the system can be set up to sets all of the machines so that they will not move any theatrical object faster than 10% of a stage production speed. Then, when the stage show crew arrives and logs in, the system will be set up for the stage production set of rules. The maintenance set of rules are then turned off so that theatrical objects can then move with the show rules allowing top speed, maximum heights and length, other stage show functionality, etc.

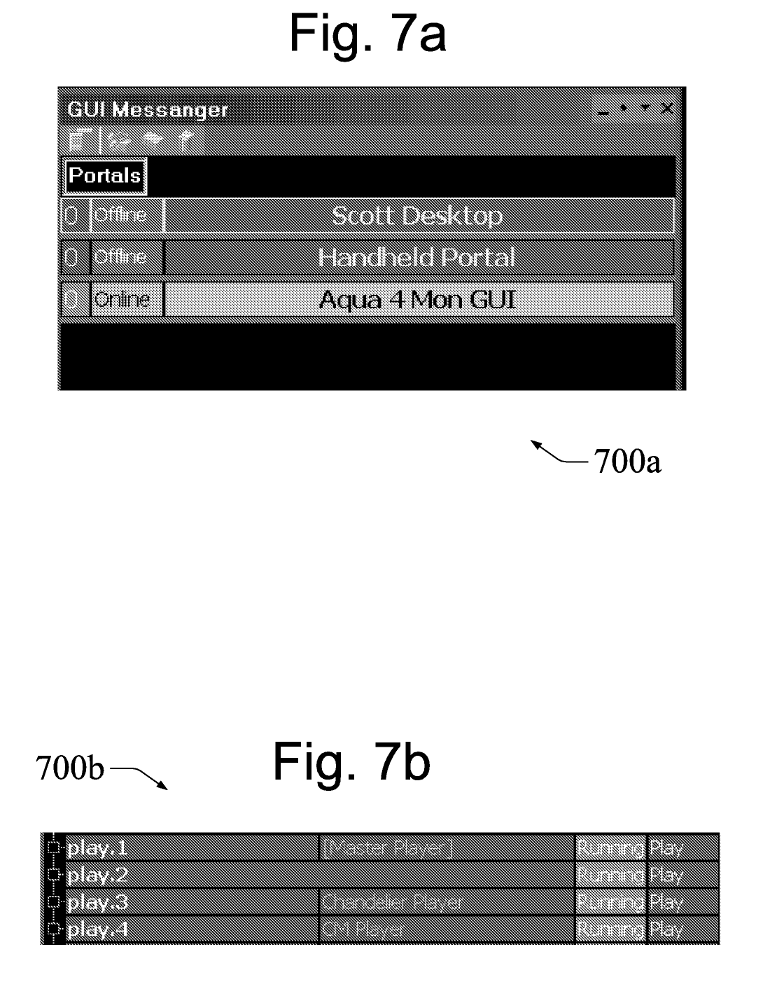

FIG. 7a shows screen shot 700a depicts a graphical user interface messenger for an operator console. The operator console, unlike prior art systems, due to the networking and sharing of data vectors is not the actual central point of control on the Navigator system. The Navigator system has universally available real time data about the operational status of each device, yet without a central point of control. As such, numerous operator control stations can be part of the system in a theatrical stage setting in any configuration desired at any time, all the time. For instance, simultaneously used operator controls can be a computer desk top, a palm top computer, a floor monitor graphic user interface, etc. In one theatrical stage environment, there may be five consoles, three laptops, eight palm top computers, all of which can access all data vectors being generated in real time all the time. Any such consoles can display any data for any specific machine because there is no centralized data processing, but rather all data processing is decentralized.

FIG. 7b shows screen shot 7b which is another depiction of aspects of the network architecture functionality permitted by the Navigator system, where a zoom in is shown for the screen shot 700a to show that multiple instances can be run of the same type of device on one node at the same time.

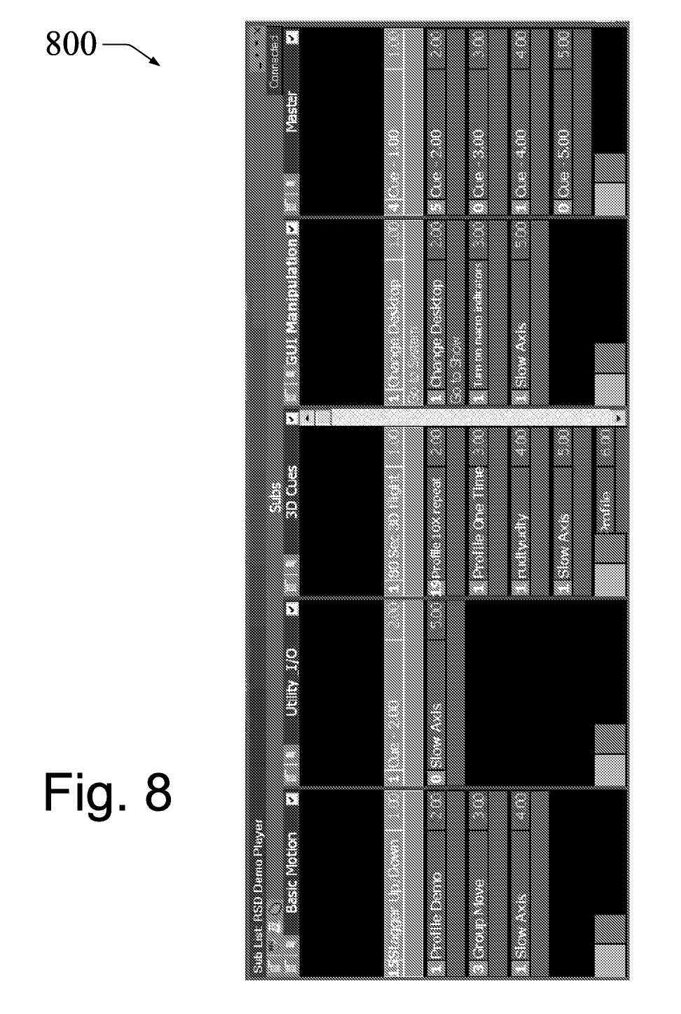

FIG. 8 shows a screen shot 800 depicting sequential motion sequences. For instance in one queue of instructions, a main curtain could be moved out, then scenery could be moved in and then there would be a drop of a main lift in the downward direction. In fact, there can be multiple lists of those queues, and then the multiple lists of queues can reside in a device called a ‘player’, where the different lists comprise the ‘player’. The lists themselves are ‘submasters’ shown in screen shot 800. The individual actions within the submasters are list of actions and the submasters are the queues, where a master is generally used to execute queues from other submasters. As such, any sequence of theatrical object movements can be executed, by demand of a system operator, any time during a stage production. This inherent flexibility is due to the network structure of the Navigator system. In contrast, the hierarchy of prior art automation software for theatrical object motion control prevented such flexibility, thus preventing on-the-fly reordering of theatrical object movements during a stage show and mandating a ridge sequence of events..

When a stage production starts and runs, one of more nodes can join at any point of time in the show. There are times when a theatrical object is not to be moved at all during a show, in which case a node corresponding to that theatrical object can be taken offline so there is no way that object can be moved or the node brought online accidentally. When the node is intentionally brought back online, the node sends a universally available data vector announcing that it is back online. Each node is independently operated using decentralized processing, making the Navigator system unstoppable by any one node failure while all operational nodes have access to all other nodes operational data in a sharing of network data traffic. Each node is a current connection into the network, and there are multiple socket connections into the network each providing node communications into the network through the corresponding machine. As such, as each individual machine is killed (e.g.; taken off line), the remaining nodes will load share.

The Navigator system has been architected so that there will be no single point of failure. This means that there is no single failure can cause a dangerous condition to occur. One failures may cause an object to stop movement or otherwise not work correctly, but such a failure will not cause dangerous situations like a runaway stage prop. The architecture uses rigorous mechanical and software analysis standards, including fault analysis and failure mode effect analysis that can simulate failures at different branches of a tree-like system structure. This architecture allows predictions for what will happen in different failure scenarios. If a single point of failure is found, the rules can be reset to avoid the same. That way, if an individual machine is turned off and then turned on again, every other machine continues to run without affecting the rest of the network in any way. Moreover, the robust, virtually crash-proof nature of the QNX RTOS helps in failure avoidance, those it is transparent to the user of the Navigator system via available user interfaces.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. We claim each method, apparatus, device, system, means for providing a function, step for providing a function, and combinations thereof as illustrated, shown, implied, and described.
